(19) United States
(12) Patent Application Publication
(10) Pub. No.: US 2020/0226989 A1
(43) Pub. Date: Jul. 16, 2020

(54) Systems and Methods for Driving a Display Device

(71) Applicant: COMPOUND PHOTONICS U.S. CORPORATION, Chandler, AZ (US)

(72) Inventor: Kevin M. FERGUSON, Beaverton, OR (US)

(21) Appl. No.: 16/620,502

(22) PCT Filed: Jun. 22, 2018
(86) PCT No.: PCT/US2018/039172

§ 371 Date: Dec. 7, 2019

Related U.S. Application Data
(60) Provisional application No. 62/523,717, filed on Jun. 22, 2017.

(51) Int. Cl. G09G 3/36

(52) U.S. Cl. CPC G09G 3/3607; G09G 3/3648; G09G 2320/0209; G09G 2320/0626; G09G 2320/0242

(57) ABSTRACT

The present invention discloses checkerboarding and serration systems and methods that achieve reduced persistence and/or reduced latency in a display device. In operation, a processor, executes instruction for displaying an image at the display. The operations include driving a set of pixels of the display utilizing a PWM method that generates a plurality of pulses caused by pulse-width modulation (PWM), energizing a first pixel associated with a first frame for a predetermined period of time using a first pulse of the PWM, serrating a second pulse during the period of time the first pixel is energized.

### CROSS REFERENCE

The present application claims priority to U.S. patent application Ser. No. 62/523,717, filed on Jun. 22, 2017, 2017.

### TECHNICAL FIELD

The present invention relates to a display device. More particularly, the present invention is directed to systems and methods for driving a display device.

### BACKGROUND

Head mounted displays are used to render images intended to show objects mapped to the viewer's perspective coordinate system, such as is the case with virtual, augmented and mixed reality systems For example, such systems require that the motion of the head not cause artifacts such as blurring, color break-up (such as red, green and blue rain-bow fringing from bright objects against dark backgrounds), stereoscopic depth modulation (e.g., where objects appear to be unstable with regard to distance from viewer) and related spatiotemporal issues. These issues are caused by objects rendered on the display in a way that does not integrate light properly on the retinas of the respective eyes of the viewer.

Examples of artifacts that may appear in the image may include, for example, blurring and color fringing artifacts. Blurring artifacts can blur a portion or all of the image placed in, for example, virtual reality applications when the viewer's head moves. During head motion, stationary virtual objects must be moved across the display in the opposite direction in order to appear stationary. For example, where the viewer tracks a virtual stationary object during head motion, the virtual stationary object is focused on the viewer's retinas within viewer's ability to track the object. In a perfect system, the object becomes stationary on each retina over time. If the display of the image occurs during a substantial portion of a video frame time, for frame rates typical for state of the art systems, virtual stationary objects are held still on the display during this time while the head moves, thus resulting in the objects moving across the viewer's retina. Objects that move across the viewer's retina within each frame, repeatedly over several frames, are perceived as blurry (e.g., the integral of each object at various positions over time).

Color fringing artifacts may occur in images that are rendered in, for example, color sequential imaging systems. For example, a single imager (e.g., a single device) can be used to render red, green and blue separately in time. This is known as color sequential rendering. In a head mounted application, due to head motion, the red, green and blue color images are nominally rendered with different registration on the viewer's retinas. Thus, especially along boundaries of white and black, these individual colors can be seen. Thus, the persistence of an object in the image is long, and superposition of objects with position error across the retina may lead to color fringing artifacts.

Liquid Crystal on Silicon (LCoS) devices have large liquid crystal rise and fall times and thus lack in generating images having short persistence. Also, LCoS devices are typically too slow for AR, VR, MR applications, where sufficiently low cost, high contrast devices are required. Part of the speed issue has to do with liquid crystal rise and fall times being too large. Another part of the speed issue has to do with the electronic drive of the device and the time it takes to change the drive voltage of all the pixel electrodes from one voltage to another. Further, traditionally there is a trade-off between reduced rendering time and imager bit depth.

Also, if there is a lag between head motion, object manipulation or other viewer actions, and the displayed result corresponding to these actions, then the lag becomes noticeable and generally objectionable. The lag can occur because of the processing required for tracking the viewer and other objects, updating the internal models of real and virtual objects, rendering to stereoscopic or three-dimensional (3-D) holographic digital video data, and sending the video data to the display. When the bandwidth and frame rate is insufficient to send the video data, motion artifacts may be noticed. The bandwidth of systems may also be limited by cost and system considerations, for example, bulky cables of tethered systems, etc. Bandwidth problems may contribute to latency problems associated with a display device or system.

### SUMMARY

The present invention is directed to, for example, processing image data, checkerboarding and/or serration systems and/or methods for driving a display device, and achieving reduced latency, persistence, and/or bandwidth. The checkerboarding and/or serration systems and/or methods of the present invention achieves outputs that may be utilized in systems requiring short persistence and/or short latency, for example, head-mounted display systems and/or methods.

It is to be understood that both the foregoing general description and the following detailed description are exemplary and explanatory and are intended to provide further explanation of the invention as claimed.

### DESCRIPTION OF THE DRAWINGS

The accompanying drawings, which are included to provide a further understanding of the invention and are incorporated in and constitute a part of this specification, illustrate an embodiment of the invention and together with the description serve to explain the principles of the invention.

FIG. 1A is a block diagram of an embodiment of the present invention.

FIG. 1A is a block diagram of an alternate embodiment of the present invention.

FIG. 2 is a block diagram of a control system of the graphics processing device in FIG. 1A.

FIG. 3 is a block diagram of a control system of the digital drive device in FIG. 1A.

FIG. 4 is a flow chart illustrating a checkerboard sequence of the control system of FIG. 2.

FIG. 5 is a checkerboard processing alternates between two complimentary checkerboard patterns over 2 frames.

FIG. 6 is a spatial and temporal separation of color sub-frames due to checkerboard processing.

FIG. 7 zooms into FIG. 6 in order to point out color bleed.

FIG. 8 shows color bleed at two levels.

FIG. 9 illustrates color bleed between red and green.

FIG. 10 compares color bleed between green and blue.

FIG. 11 is timing diagram for short persistence color sequential data transfer.

FIG. 12 is a flow chart illustrating a serration sequence of the control system of FIG. 2.

FIG. 13 is a prototype bit sequence matrix for serrated PWM used in short persistence drive.

FIG. 14 is a graph illustrating displacement for the serrated PWM of FIG. 13.

FIG. 15 is a graph illustrating the second displacement for the serrated PWM of FIG. 13.

FIG. 16 illustrates a serration method in accordance with the present invention.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, illustrative, and similar terms, refer expansively to embodiments that serve as an illustration, specimen, model or pattern.

Descriptions are to be considered broadly, within the spirit of the description. For example, references to connections between any two parts herein are intended to encompass the two parts being connected directly or indirectly to each other. As another example, a single component described herein, such as in connection with one or more functions, is to be interpreted to cover embodiments in which more than one component is used instead to perform the function(s). And vice versa—i.e., descriptions of multiple components described herein in connection with one or more functions are to be interpreted to cover embodiments in which a single component performs the function(s).

In some instances, well-known components, systems, materials, or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

It is to be understood that both the foregoing general description and the following detailed description are exemplary and explanatory and are intended to provide further explanation of the invention as claimed. While the present technology is described herein with illustrative embodiments for particular applications, it should be understood that the technology is not limited thereto. Those skilled in the art with access to the teachings provided herein will recognize additional modifications, applications, and embodiments within the scope thereof and additional fields in which the technology would be of significant utility.

The present invention is directed to methods for processing image data and/or driving a display device, which involve checkerboarding methods and/or serration methods to achieve reduced latency, persistence, and/or bandwidth. The checkerboarding and/or serration methods, in accordance with the present invention, achieve outputs that may be utilized in systems, for example image systems or devices, display and projection systems that require short persistence and/or short latency (e.g., head-mounted display systems and/or methods).

Embodiments of the present invention are described primarily in connection with augmented reality (AG) and/or virtual reality (VR), for exemplary purposes. However, embodiments of the present invention, can be applied in other hybrid, mixed reality (MR), extended reality (XR) or other alternative realities systems, devices or methods, or may be utilized in other devices or systems (e.g., other image display and/or projection systems, displays, and/or methods of displaying an image, and/or light modulation devices, systems, and/or methods.

The checkerboarding and serration, for example use of a GPU to perform drive circuit processing, may be applied to any display application, as well as phase modulation methods for a wide range of applications for programmable optics devices.

The methods of the present invention achieve, for example, short persistence, low latency, and/or increased bit depth with the given system bandwidth. The methods may also take advantage of human visual perception limits at high spatiotemporal frequencies (e.g., simultaneously high spatial and high temporal frequencies). By decimating video content in a way that removes high spatiotemporal frequencies for a sufficiently high frame rate and resolution video, a perceptually lossless compression is achieved or substantially achieved by a process that involves, for example, checkerboard patterns. Stated another away, utilizing checkerboard patterns allow original data to be reconstructed from compressed data.

In embodiments of the present invention, a checkerboarding process occurs prior to converting video to bit planes for a spatial light modulator (e.g., a display, a microdisplay, a liquid crystal-on-silicon (LCoS) display device, a liquid crystal display (LCD) device, an light-emitting diode (LED) or organic LED (OLED) device, an optically addressed spatial light modulator (OASLM) device, and/or digital display device).

Reference will now be made in detail to an embodiment of the present invention, an example of which is illustrated in the accompanying drawings.

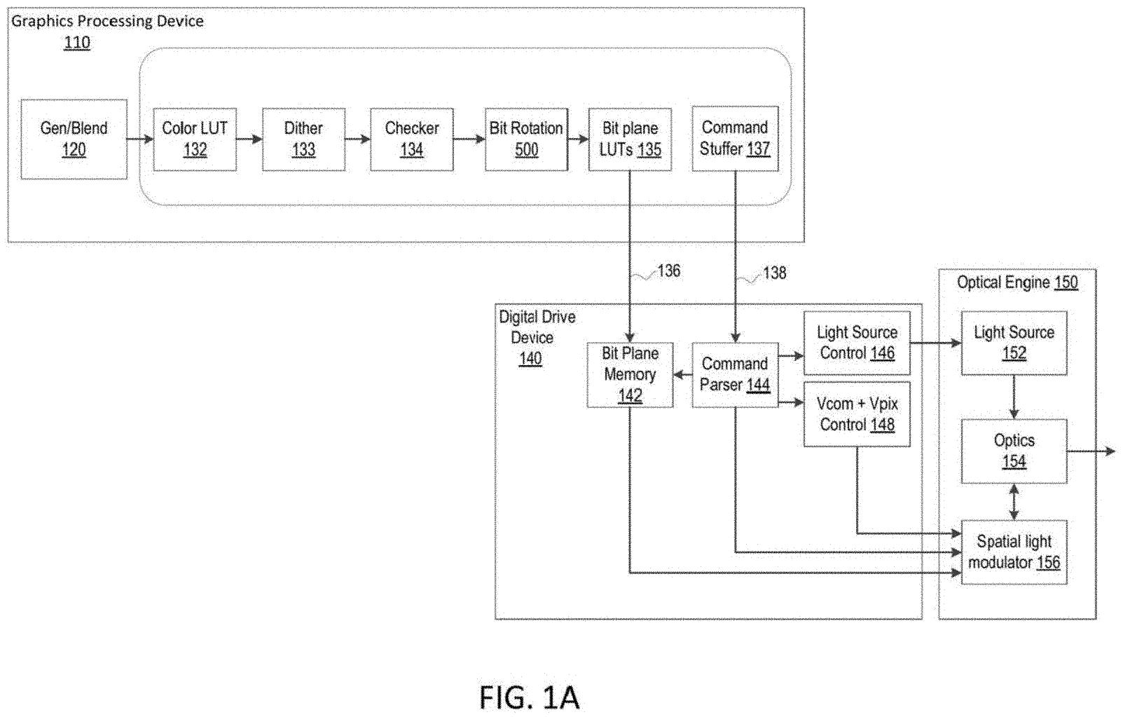

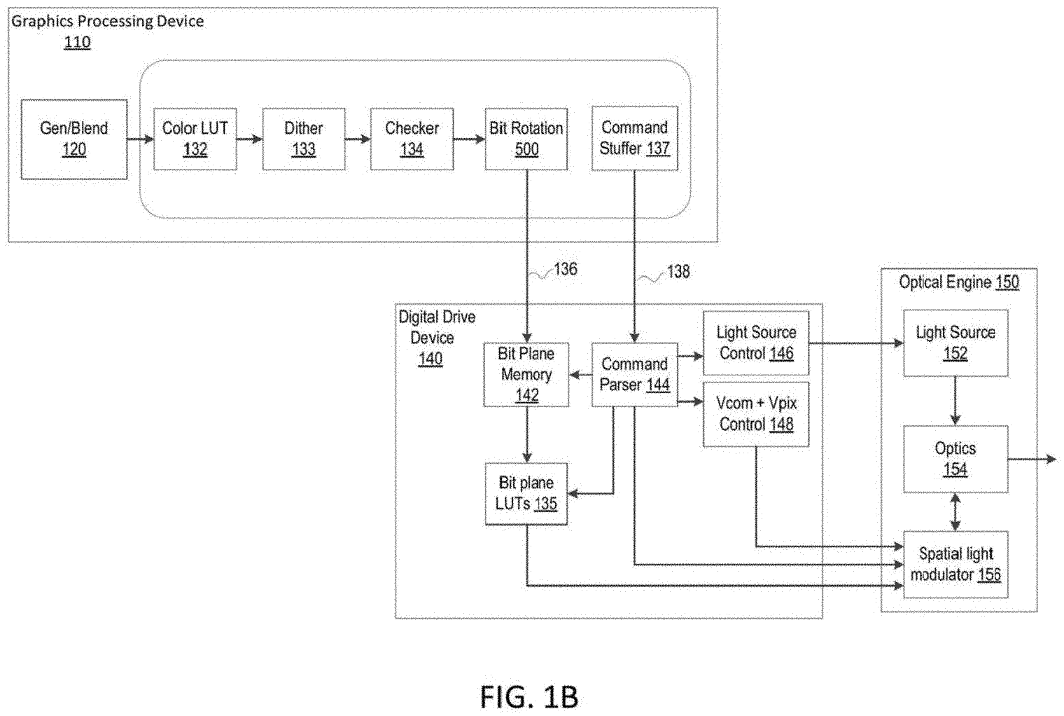

Overall System—FIGS. 1-3

FIG. 1 is a display device and/or system in accordance with the present invention. A drive system, in accordance with the present invention, may include, the graphics processing device 110, a digital drive device 140, and an optical engine 150, as shown in FIGS. 1 and 2, and described below.

In some embodiments, the graphics processing device 110 may include a generator and blender (gen/blend) module 120. The gen/blend module 120 may generate and/or blend objects. For example, in mixed reality and immersive augmented reality applications, the blender 120 blends these generated objects with images obtained via a camera or other visual representations of objects (e.g., real objects). The gen/blend 120 produces data, for example, video and/or image data output. In embodiments of the present invention, the gen/blend module 120 produces data, for example, video and/or image data output in alternative realities systems, devices or methods, (e.g., AR, VR, and/or MR). In an exemplary embodiment of the present invention, the gen/blend module 120 produces AR images, for example, at a head-mounted display (HMD) system input, (e.g., RGB) video frames. In embodiment of the present invention, the gen/blend module 120 may be incorporated into a drive or system that generates images (e.g., AR image), for example HMD devices or system. In some cases, the generated images may be blended with images from a camera. In alternative reality systems that incorporate embodiments of the present invention, the GPU performs graphics processing and/or produces frames for display, for example, on a head mounted display.

In an embodiment of the present invention, the graphics processing device 110 includes a processor 130 or is associated with a processor 130 internal or external to the graphic processing device 110. An embodiment of the present invention may be implemented downstream of the frames rendered for a display (e.g., a head mounted display system). In an embodiment of the present invention, the GPU processor 130 may execute software modules of the graphics processing device 110. For example, the processor 130 executes software modules such as a dither module 133, a checkboard module 134, and command stuffer 136.

In execution of the aforementioned modules, the processor 130 may access data stored on the one or more look-up tables (LUTs) located on a storage (e.g., memory) internal or external to the graphics processing device 110. For example, a color LUT 132 and a bit plane LUT 135 are accessed at an internal memory 210 of the graphics processing device 110. It would be recognized by one of skill in the art that more or fewer modules may be executed by the processor 130 without departing from the scope of the invention.

In an embodiment of the present invention, the Color LUT 132 may be utilized for color correction, including any inter-color channel type processing required. As an example, the native red, green and blue color coordinates may differ from a desired standard, such as standard RGB (sRGB) based on the International Telecommunication Union Recommendation 709. In an embodiment of the present invention, the Color LUT 132 allows for substantially accurate color correction given that the display nominally has a power law (gamma) output profile.

In an embodiment of the present invention, the spatial and temporal dither module 133, in accordance with the present invention, may be used to perceptually extend bit depth beyond the native display bit depth. The dither module 133/210 may be utilized, for example, in recovering fast moving scenes by exploiting high-speed illumination “dithering” digital light processing (DLP) projectors.

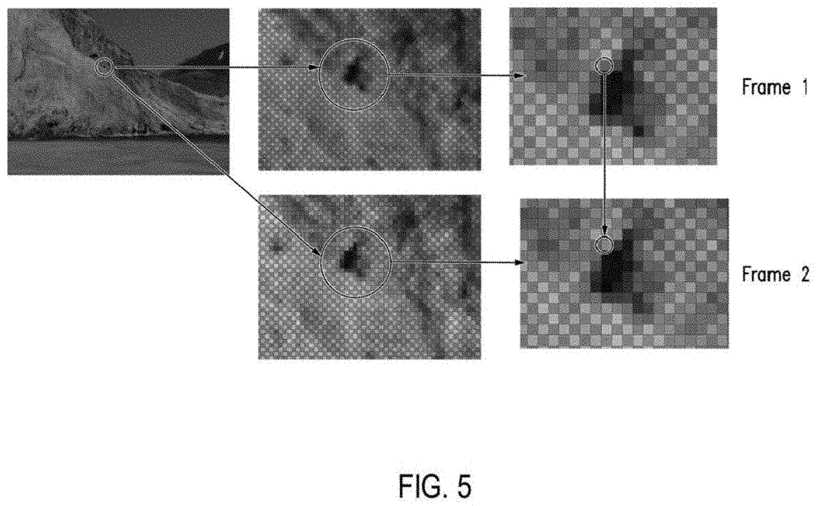

The checkerboard 134/400 module performs a checkerboarding method in accordance with the present invention. The concept of checkerboarding is described in further detail below in association with FIGS. 5-10.

In an embodiment of the present invention, the bit plane LUT 135 is accessed from the memory 210 of the graphics processing device 110 (which may be internal or external to the graphics processing device 110) and the processor 130 accesses the bit plane LUT 135 (i.e., an instantaneous state of all output binary pixel electrode logic of the spatial light modulator, for example, LCoS device 156) given each pixel's digital level value and the time. In an embodiment of the present invention, the processor 130 may execute a module (e.g., bit plane LUTs 135) that generates bit planes.

The digital drive device 140 receives data (e.g., commands 136, 138) from the graphics processing device (e.g., processor 260) and arranges (e.g., compresses) the received data prior to communicating image data to the optical engine 150. The digital drive device 140 may include a memory 310/110 (which may be internal or external to the device and/or shared with another device). The memory 310 may include several categories of software and data, including, a database 330, and I/O device drivers 350.

The database 330 may include various programs, for example, a command parser module 144 that, when executed by the processor 360 or processor 130, parses and/or processes data received by the device 140.

The storage device or database 330 represents the static and dynamic data (e.g., bit plane memory 142, command parser 144, light control source 146, etc.) and may be used by the I/O device drivers 350 and/or other software programs that may reside, for example, in the memory 310.

In an embodiment of the present invention, bit rotation by a bit rotation module 500 and process that occurs outside of the graphics processing device 110. In an embodiment, bit planes are sent from the GPU 130 to the integrated circuit (IC) chip of the LCoS driver (e.g., Nova/P4D), and the LCoS driver IC includes a LUT that takes the bit planes as input (via local bit-Cache memories). The LUTs located at the GPU 130 can send final bit planes directly to the LCoS driver IC.

In an embodiment of the present invention, bit rotation by a bit rotation module and process that occurs outside of the graphics processing device 110. In an embodiment of the present invention, the bit rotation module/process 500 may involve extracting a specific bit number, for example the most significant bit (MSB)) by a processor. The resulting bit planes are used as the input of the bit plane and/or stored in the Bit Plane (otherwise known as logic plane) LUT 135. In some embodiments, the LUT 135 may be in the LCoS drive device 140 and the bit plane inputs may be accessed by, for example, the GPU 130 or device processor 260, and may result in significant reduction in bandwidth requirements of the LCoS drive device 140, as well as reduced memory requirements.

In an embodiment of the present invention, the command stuffer 137 inserts commands in the video path in areas not seen by the end user. In an embodiment of the present invention, these commands control, for example, light source(s) 152 such as laser(s), drive voltages (e.g., such as the LCoS' Vcom (common electrode)) and Vpix (pixel electrode) voltages directly, or indirectly via, for example, the Light Source Control module 146 and the Vcom Control module 148. In an embodiment of the present invention, the modules 146 and 148 may be implemented in hardware and/or software. By moving the control over these commands upstream, for example, in the graphics processor device 110, having a processor, for example processor 260, under software control, real-time updates to the spatial light modulator 156 (e.g., display or LCoS device) may occur. This enables dynamic control of the spatial light modulator 156 for new capabilities such as mitigation of rapid variance in temperature, illumination, ambient conditions, video average picture level (for example for dynamic aperture type increase in dynamic contrast), display modes (such as maximum brightness vs maximum fidelity, etc.).

The digital drive device 140 may be, for example, a component of a computing system, head mounted device, and/or other display for a device (e.g., LCoS, LED). In an embodiment of the present invention, bit plane commands 136 and stuffer commands 138 from the GPU are relayed to respective HW (e.g., lasers, DACs, etc.) and sends bit planes to the LCoS at the times specified by bit plane commands.

In an embodiment of the present invention, the device processor 140 includes a bit plane memory 142, where the bit planes received from the commands 136 from the bit plane LUTs are buffered prior to being sent to the digital drive device 140 and/or spatial light modulator 156 (e.g., display and/or LCoS device) at the appropriate time specified by the respective bit plane command, for example, are buffered in bit plane memory 142 by command parser 144.

In an embodiment of the present invention, the bit plane LUT 135 may be located in the graphic processing device 110 (FIG. 1A). In another embodiment, the bit plane LUT 135 may reside in the digital drive device 140 (FIG. 1B). In an embodiment of the present invention, the graphic processing device device 110, in accordance with the present invention, may include a bit rotation module 500 that generates or outputs one or more bit planes to the bit plane LUT. In an embodiment of the present invention, the bit rotation module 500 may be included in the drive device 140. In an embodiment of the present invention, the bit rotation module 500 rotates bits from, for example, a data stream (e.g., video data, modified gen/blend data and/or unmodified gen/blend data). In an embodiment of the present invention, gen/blend data, for example, gen/blend data output from gen/blend module 120 may be modified by, for example, by color LUT data 132, the dither module 133, and/or checkerboard module 134.

In an embodiment of the present invention, the digital drive device 140 also includes a command parser 144. The command parser 144 parses the commands 138 received from the command stuffer 137.

In an embodiment of the present invention, a Light Source Control 146 controls the light source(s) 152 such as lasers or LEDs by controlling analog currents via DACs, digital enable or disable controls, etc.

In an embodiment of the present invention, the Vcom+Vpix Control 148 controls the LCoS' Vcom (common electrode) and Vpix (pixel electrode) voltages.

In an embodiment of the present invention the optical engine 150 contains the display device and all other optical devices required to complete the head mounted display. In an embodiment of the present invention, this may include optics 154, for example, lenses, polarizers, etc. and light sources 152.

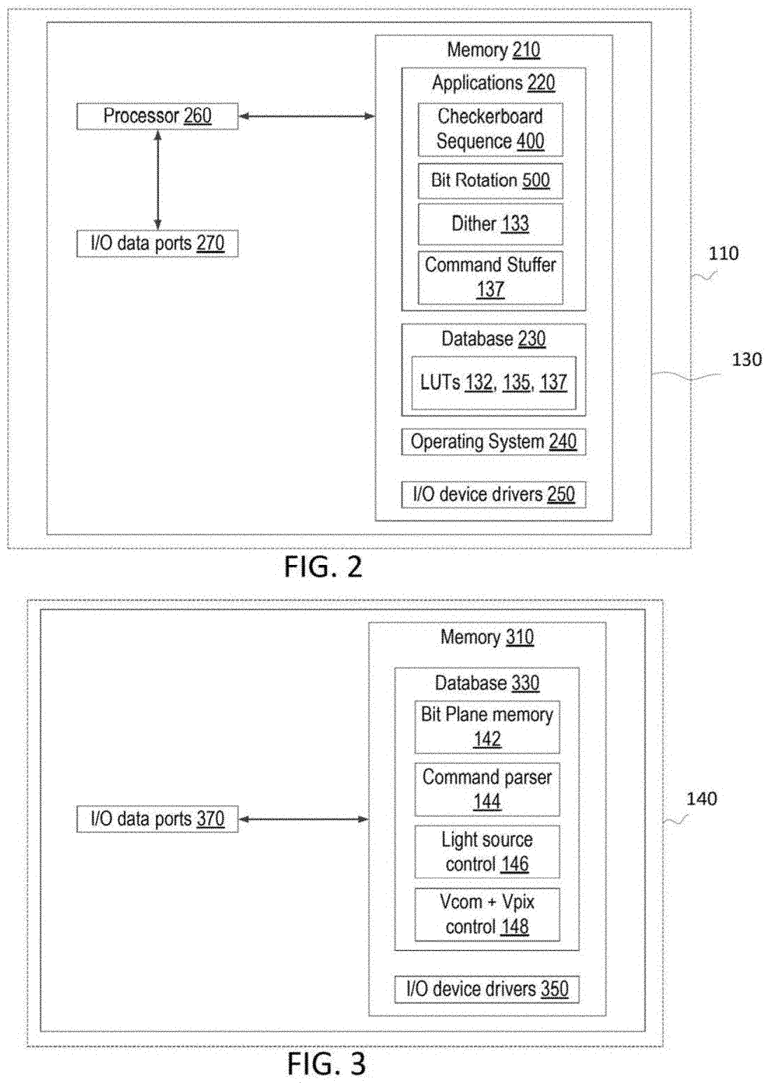

It should be understood that FIGS. 2-3 and the description above are intended to provide a brief, general description of a suitable environment in which the various aspects of some embodiments of the present disclosure can be implemented. While the description refers to computer-readable instructions, embodiments of the present disclosure can also be implemented in combination with other program modules and/or as a combination of hardware and software in addition to, or instead of, computer readable instructions.

The term “application,” or variants thereof, is used expansively herein to include routines, program modules, programs, components, data structures, algorithms, and the like. Applications can be implemented on various system configurations including single-processor or multiprocessor systems, minicomputers, mainframe computers, personal computers, hand-held computing devices, microprocessor-based, programmable consumer electronics, combinations thereof, and the like.

In an embodiment of the present invention, the graphics processing device 110 includes a graphics processing unit (GPU) 130. The graphics processing device 110 may be a separate device or may be embedded in a CPU die (for example, a CPU die associated with a device in which the graphical processing unit is incorporated). The graphics processing device 110 executes logic (e.g., software) that performs image processing.

The graphics processing device 110 includes a control processing device illustrated in FIG. 2. The control processing device includes a memory 210. The memory 210 may include several categories of software and data including, applications 220, a database 230, an operating system (OS) 240, and I/O device drivers 250.

As will be appreciated by those skilled in the art, the OS 240 may be any operating system for use with a data processing system. The OS 240 provides scheduling, input-output control, file and data management, memory management, and communication control and related services, all in accordance with known techniques. The I/O device drivers 250 may include various routines accessed through the OS 240 by the applications 220 to communicate with devices and certain memory components.

The applications 220 can be stored in the memory 210 and/or in a firmware (not shown in detail) as executable instructions and can be executed by a processor 260.

The processor 260 could be multiple processors, which could include distributed processors or parallel processors in a single machine or multiple machines. The processor 260 can be used in supporting a virtual processing environment. The processor 260 may be a microcontroller, microprocessor, application specific integrated circuit (ASIC), programmable logic controller (PLC), complex programmable logic device (CPLD), programmable gate array (PGA) including a Field PGA, or the like. References herein to processor executing code or instructions to perform operations, acts, tasks, functions, steps, or the like, could include the processor 260 performing the operations directly and/or facilitating, directing, or cooperating with another device or component to perform the operations.

Processors utilized in embodiments of the present invention may include a commercially available processor such as a Celeron, Core, or Pentium processor made by Intel Corporation, a SPARC processor made by Sun Microsystems, an Athlon, Sempron, Phenom, or Opteron processor made by AMD Corporation, other commercially available processors and/or or other processors that are or will become available.

Some embodiments of the processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor mat enables parallel execution of multiple threads. In addition, those of ordinary skill in the related will appreciate that a processor may be configured in what is generally referred to as 32 or 64 bit architectures, or other architectural configurations now known or that may be developed in the future. A processor typically executes an operating system, which may be, for example, a Windows type operating system from the Microsoft Corporation; the Mac OS X operating system from Apple Computer Corp.; a Unix or Linux-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages.

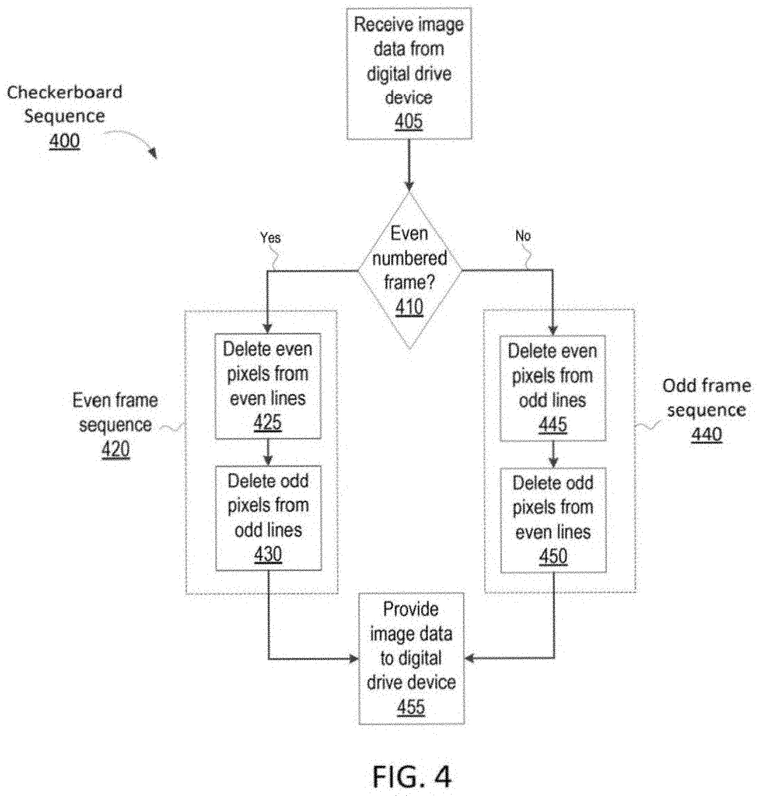

The applications 220 include various programs, such as a checkerboard sequence 400 (shown in FIG. 4) described below that, when executed by the processor 260, process data received by the device 110.

The applications 220 may be applied to data stored in the database 230, along with data, e.g., received via the I/O data ports 270. The database 230 represents the static and dynamic data (e.g., color LUT 132, bit plane LUTs 135) used by the applications 220, the OS 240, the I/O device drivers 250 and other software programs that may reside in the memory 210.

While the memory 210 is illustrated as residing proximate the processor 260, it should be understood that at least a portion of the memory 210 can be a remotely accessed storage system, for example, a server on a communication network, a remote hard disk drive, a removable storage medium, combinations thereof, and the like. Thus, any of the data, applications, and/or software described above can be stored within the memory 210 and/or accessed via network connections to other data processing systems (not shown) that may include a local area network (LAN), a metropolitan area network (MAN), or a wide area network (WAN), for example. It should be understood by one of ordinary skill in the art that embodiments of the present invention may utilize one storage device and/or one processing device, instead of multiple storage devices and/or multiple processing devices.

As described above, the modules and software applications 220 may include logic that is executed by processors 260. “Logic”, as used herein and throughout this disclosure, refers to any information having the form of instruction signals and/or data that may be applied to affect the operation of a processor. Software is one example of such logic. Examples of processors are computer processors (processing units), microprocessors, digital signal processors, controllers and microcontrollers, etc. Logic may be formed from computer-executable instructions stored on a non-transitory computer-readable medium such as memory or storage 210, including, for example, random access memory (RAM), read-only memories (ROM), erasable/electrically erasable programmable read-only memories (EPROMS/EEPROMS), flash memories, etc. Logic may also comprise digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

The memory 210 may include any of a variety of known or future memory storage devices that can be used to store the desired information and that can be accessed by a computer. Computer readable storage media may include non-transitory volatile and non-volatile, removable and non-removable media implemented in any method or technology for storage of information such as computer readable instructions, data structures, program modules, or other data. Examples include any commonly available random access memory (RAM), read-only memory (ROM), electronically erasable programmable read-only memory (EEPROM), digital versatile disks (DVD), magnetic medium, such as a resident hard disk or tape, an optical medium such as a read and write compact disc, and/or other memory storage device. Memory storage devices may include any of a variety of known or future devices, including a compact disk drive, a tape drive, a removable hard disk drive, USB or flash drive, or a diskette drive. Such types of memory storage devices typically read from, and/or write to, a program storage medium such as, respectively, a compact disk, magnetic tape, removable hard disk, USB or flash drive, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with memory storage device.

In some embodiments, a computer program product is described comprising a computer usable medium having control logic (computer software program, including program code) stored therein. The control logic, when executed by a processor, causes the processor to perform functions described herein. In other embodiments, some functions are implemented primarily in hardware using, for example, a hardware state machine. Implementation of the hardware state machine so as to perform the functions described herein will be apparent to those skilled in the relevant arts. Input-output controllers could include any of a variety of known devices for accepting and processing information from a user, whether a human or a machine, whether local or remote. Such devices include, for example, modem cards, wireless cards, network interface cards, sound cards, or other types of controllers for any of a variety of known input devices. Output controllers could include controllers for any of a variety of known display devices for presenting information to a user, whether a human or a machine, whether local or remote. In the presently described embodiment, the functional elements of a computer communicate with each other via a system bus. Some embodiments of a computer may communicate with some functional elements using network or other types of remote communications.

As will be evident to those skilled in the relevant art, an instrument control and/or a data processing application, if implemented in software, may be loaded into and executed from system memory and/or a memory storage device. All or portions of the instrument control and/or data processing applications may also reside in a read-only memory or similar device of the memory storage device, such devices not requiring that the instrument control and/or data processing applications first be loaded through input-output controllers. It will be understood by those skilled in the relevant art that the instrument control and/or data processing applications, or portions of it, may be loaded by a processor, in a known manner into system memory, or cache memory, or both, as advantageous for execution. Also, a computer may include one or more library files, experiment data files, and an internet client stored in system memory. For example, experiment data could include data related to one or more experiments or assays, such as detected signal values, or other values associated with one or more sequencing by synthesis (SBS) experiments or processes. Additionally, an internet client may include an application enabled to access a remote service on another computer using a network and may for instance comprise what are generally referred to as “Web Browsers”. In the present example, some commonly employed web browsers include Microsoft Internet Explorer available from Microsoft Corporation, Mozilla Firefox from the Mozilla Corporation, Safari from Apple Computer Corp., Google Chrome from the Google Corporation, or other type of web browser currently known in the art or to be developed in the future.

Also, in the same or other embodiments an internet client may include, or could be an element of, specialized software applications enabled to access remote information via a network such as a data processing application for biological applications. Computers or processors may be part of a network. A network may include one or more of the many various types of networks well known to those of ordinary skill in the art. For example, a network may include a local or wide area network that may employ what is commonly referred to as a TCP/IP protocol suite to communicate. A network may include a network comprising a worldwide system of interconnected computer networks that is commonly referred to as the internet, or could also include various intranet architectures. Those of ordinary skill in the related arts will also appreciate that some users in networked environments may prefer to employ what are generally referred to as “firewalls” (also sometimes referred to as Packet. Filters, or Border Protection Devices) to control information traffic to and from hardware and/or software systems. For example, firewalls may comprise hardware or software elements or some combination thereof and are typically designed to enforce security policies put in place by users, such as for instance network administrators, etc.

II. Checkerboarding Process—FIGS. 4-11

FIG. 4 is a flow chart illustrating methods for performing a checkboard sequence 400. In this checkerboarding method in accordance with the present invention, the pattern changes over two frames. Specifically, the sequence 400 may create a checkerboard pattern by the graphics processing device processor 260 receiving image data (step 405) from the digital device drive 140. The processor 260 can determine if the image data received corresponds to an even frame or odd frame (step 410) and executes one or more even frame sequences 420 and/or odd frame sequences 440. Specifically, in the even frames sequence 420, the even pixels are deleted from the even lines (step 425) and the odd pixels are deleted from the odd lines (step 430), and in the in the odd frames sequence 440, the even pixels are deleted from the odd lines (step 445) and the odd pixels are deleted from the even lines (step 450). Once the image data has been processed, the processor 260 provides the processed image data back to the digital drive device 140 for display (step 455).

In some embodiments, deleting pixels is accomplished by replacing the 1's with 0's within the coding. In some embodiments, deleting pixels can be accomplished by skipping or not sending the selected pixel data altogether.

It should be understood that the steps of the methods are not necessarily presented in any particular order and that performance of some or all the steps in an alternative order, including across these figures, is possible and is contemplated.

The steps have been presented in the demonstrated order for ease of description and illustration. Steps can be added, omitted and/or performed simultaneously without departing from the scope of the appended claims. It should also be understood that the illustrated method or sub-methods can be ended at any time.

In certain embodiments, some or all steps of this process, and/or substantially equivalent steps are performed by a processor, e.g., computer processor, executing computer-executable instructions, corresponding to one or more corresponding algorithms, and associated supporting data stored or included on a computer-readable medium, such as any of the computer-readable memories described above, including the remote server and vehicles.

FIG. 5 is an example of checkerboard processing that alternates between two complimentary checkerboard patterns over two frames. Each pixel alternates between green and magenta (i.e., red and blue). The upper left image in FIG. 5 is an example processed image. In order to illustrate the processing, this is a still image, so each frame is identical prior to checkerboard processing. The middle top and middle bottom images in FIG. 5 zoom into a portion of the still, processed image at a first frame and a second frame at a particular point in time. The right top and right bottom images in FIG. 5 are same portion of the processed image at a subsequent point in time. As illustrated the circled pixels have changed color from the first frame to the subsequent frame.

In an embodiment of the present invention, in order to, for example, increase luminance, reduce luminance spatiotemporal error, and/or reduce cross-talk between color channels while for example, reducing time between color sub-frames, the two groups of data, each taken from the 3 color channels, are made out-of-phase with regards to the checkerboard pattern. For example, the green color channel vs the red and blue (magenta), as shown in FIG. 5.

In an embodiment of the present invention, the checkerboarding method, in accordance with the present invention, reduces the required bandwidth and/or data transfer latency by alternating the turning off of one of adjacent pixels between two frames and/or sub-frames. The checkerboarding method, in accordance with the present invention, may involve offsetting the phase between color channels (e.g., sub-frames) to, for example, increase luminance, reduce crosstalk between color channels, and/or reduce time between frames (e.g., frames, sub-frames, and/or color sub-frames).

Using a checkerboard patterned decimation reduces bandwidth, and thus any associated data transfer latency, is reduced. For example, transfer latency can be reduce between 30% and 50% when compared to transfer latency without using checkerboard.

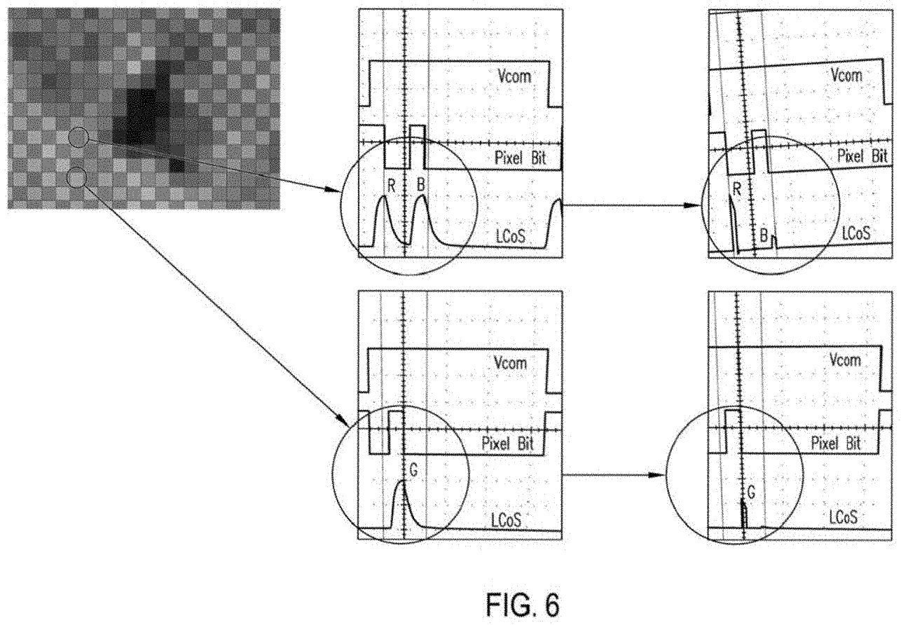

In addition, checkerboarding includes spatiotemporally alternating between the green color channel and the {red, blue} color channel pair, and consequently, any respective color sub-frames are better isolated by both space and time separation as shown in FIG. 6.

FIG. 6 is an example illustration of spatial and temporal separation of color sub-frames due to a checkerboard processing. The upper left image in FIG. 6 is a closer view of the pixel images from FIG. 5. The middle top and middle bottom images in FIG. 6 illustrate oscilloscope waveforms of drive voltages and LC response for red and blue sub-frames (middle top image) and for the green sub-frame (middle bottom image). The oscilloscope traces were captured using CW laser, for example, illumination with magenta (red and blue at in the middle top image) and green (in the middle bottom image video inputs respectively in order to show the theoretical (apart from WOB related cross-talk) spatial and temporal isolation of color sub-frame pulses. The right top and right bottom image in FIG. 6 illustrate oscilloscope waveforms of drive voltages and LC response, the same as the middle, except now with the respective wavelength laser pulses for illumination, showing further isolation.

The checkerboarding process disclosed mitigates color bleed (i.e., the end of the fall of one color pulse increasing the initial state of the rise of the next color pulse). For example, where there is a three color sequence (red, green, blue), the first color (red) and the third color (blue) are spatiotemporally separated from one another by the black portion of the checkerboarded second color (green).

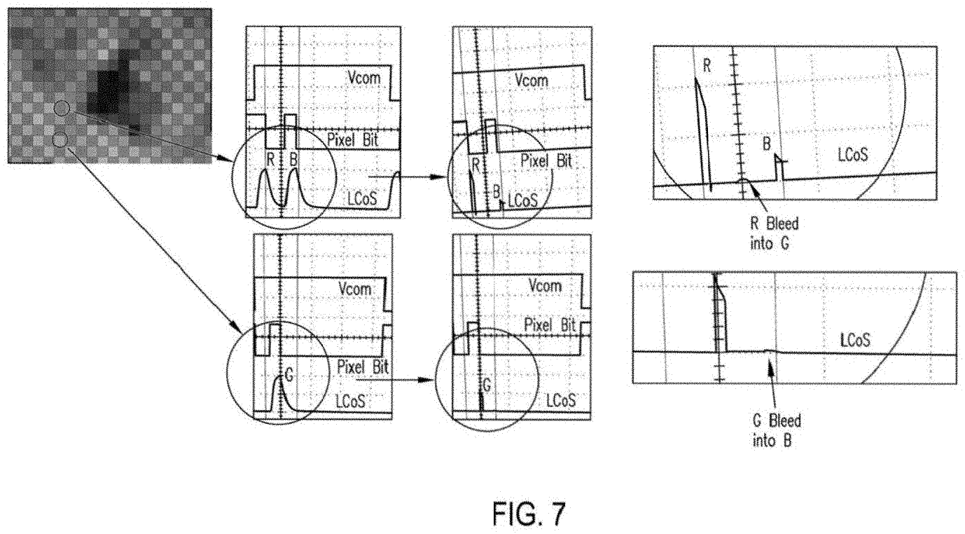

FIG. 7 illustrates the color bleed from the frames in FIG. 6. As shown, red bleed into green (top right) and green bleed into blue (bottom right).

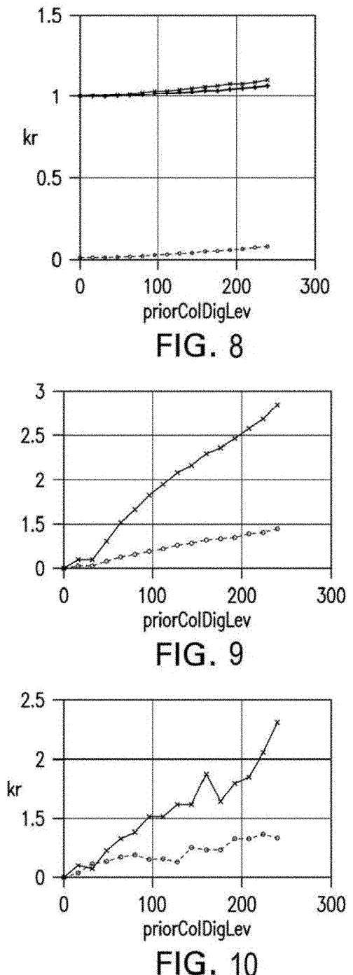

FIG. 8 illustrates the benefits of checkerboarding on a tail bleed. The tail bleed is represented by the line with “o” data points, the normalized bleed is represented by the line with “+” data points, and the total bleed is represented by the line with “x” data points. For example, utilizing a 16×16 checkerboarding process, the total bleed can be kept to between nine percent and twelve percent.

The previous sub-frame pulse' tail encroaching the current sub-frame pulse is measured by maximizing the input color of the previous sub-frame (e.g., red) and minimizing the input color of the current sub-frame (e.g., green) so the red tail bleed into green is measured using red input.

The total bleed is greater than just the superimposition of the tail from the previous sub-frame: The tail of the previous sub-frame gives the current sub-frame pulse a “head start” at a steeper portion of the rise curve, so the output error is increased for higher levels of the current sub-frame. In other words, the prior red pulse causes the current green pulse to get even brighter than would result from linear superposition.

FIG. 9 illustrates color bleed normalization of red on green as a result of luminance (x-axis) versus digital video level (y-axis). Data without checkerboarding is represented by a line with “x” data points and data utilizing 1×1 checkerboarding is represented by a line with “o” data points. As illustrated, the normalized color bleed from the initial color sub-frame pulse (red) into the second color sub-frame pulse (green) is substantially lower utilizing checkerboarding than without utilizing checkerboarding. This enables the LCoS color sub-frame pulses and respective laser pulses to be moved closer in time, while maintaining an acceptable amount of color bleed.

FIG. 10 illustrates color bleed normalization of green on blue as a result of luminance (x-axis) versus digital video level (y-axis). Data without checkerboarding is represented by a line with “x” data points and data utilizing checkerboarding is represented by a line with “o” data points. Similar to normalization of red on green illustrated in FIG. 9, the normalization utilizing checkerboarding for green on blue is substantially lower than without utilizing checkerboarding.

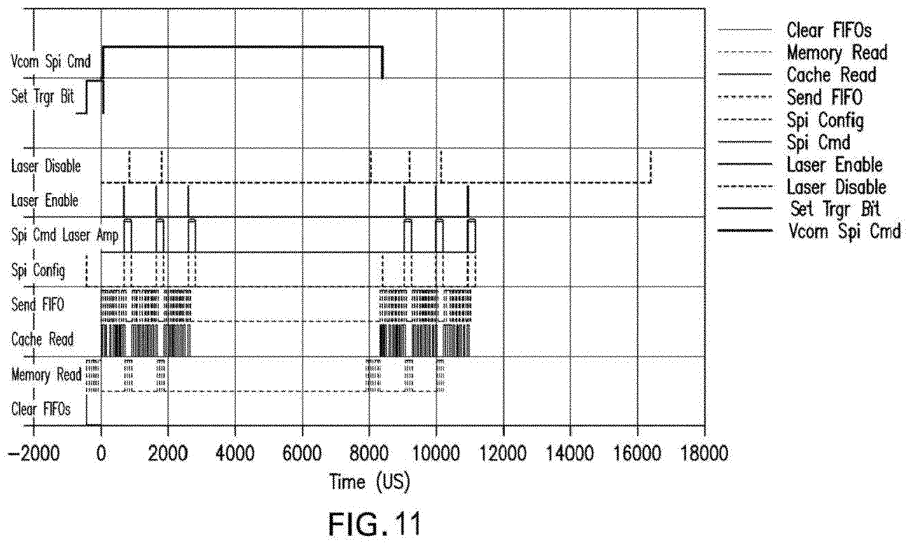

FIG. 11 is exemplary timing diagrams corresponding to application of checkerboarding, utilizing, for example, a field programmable gate array (FPGA) based system or functional equivalent such as a drive application-specific integrated circuit (ASIC). The timing diagram of FIG. 7 is an example illustration of color sequential data transfer and illumination resulting in short persistence.

As a basic example, to produce an image, (1) data must be read (e.g., from memory to cache), (2) bit planes must be sent to LCoS, and illumination (e.g., display light) of the designated color occurs at the display. For example, where three sequences (e.g., Red, Green, Blue) are to be displayed, an overlap occurs to reduce persistence as illustrated in the table below:

| | T0 | T1 | T2 | T3 | T4 | T5 | T6 |
|---|---|---|---|---|---|---|---|
| Red | Read | Send | Light | | | | |
| Seq. | Red | Red | Red | | | | |
| Green | | | Read | Send | Light | | |
| Seq. | | | Green | Green | Green | | |
| Blue | | | | | Read | Send | Light |
| Seq. | | | | | Blue | Blue | Blue |

The calculation of persistence of the display begins determinate from when the first color is illuminated (T2) to where the last color of the sequence is illuminated (T6). Specifically, the persistence is the time between T2 and T6. For example, the persistence time can be 2.1 ms utilizing checkerboarding.

Using a checkerboard patterned decimation method and/or system, may generate attenuation between adjacent pixel electrodes with differences in respective voltage drive (and/or other causes). The attenuation may be undesirable for image quality, as the attenuation changes the grey scale profile of the display device and/or system (e.g., LCoS device and/or system). This attenuation may be compensated by calibrating the drive (for example, to the target digital code to light out gamma law transfer function). Once calibrated, according to methods and systems in accordance with the present invention, each pixel is then not subject to content dependence of fringe field effects from adjacent pixels above, below, to the left nor to the right, since these are always zero (0) for a given pixel and color sub-frame, and calibration has already compensated for this attenuation. However, the 4 adjacent pixels along diagonals still vary with content, so the fringe-field effects may not be completely eliminated. From measurements taken involving systems and methods, in accordance with the present invention, the fringe field effect content dependence has been reduced by about 50% to 75% compared to video rendered without utilizing a checkerboarding. Note that checkerboarding may cause further attenuation if the display optics do not capture diffracted light due to the checkerboard pattern which causes local micro-lens (diffracted) deflection of the light. The calibration of checkerboarded grey scale profile response generally compensates for the worst case fringe-field, dark-line and/or diffracted light based attenuation, thus maximally reduces these undesirable responses.

This mitigation of fringe field effects by using a checkerboarding method and/or system, in accordance with the present invention, enables further reduction of bandwidth by enabling (via mitigation of the usual dark-line attenuation issue) the use of a pulse serration method, device, and/or system, in accordance with the present invention, for increased bit depth for a given number of bit planes.

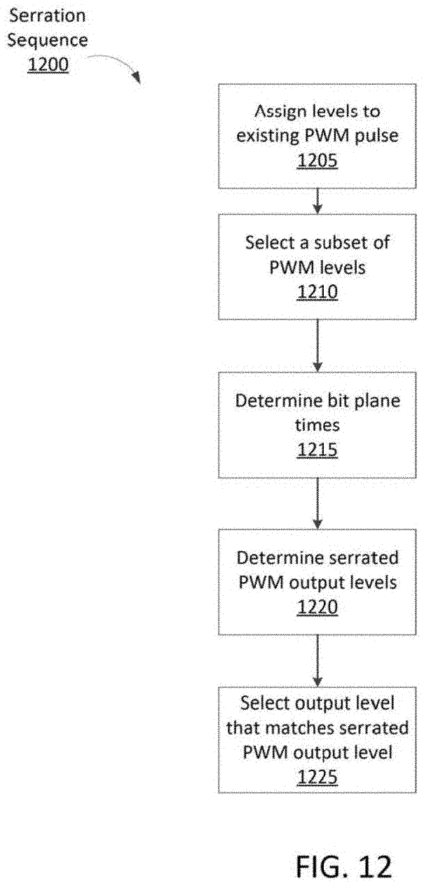

III. Serrated Pulse-Width Modulation—FIGS. 12-16

In embodiments of the present invention, a serration method is utilized to achieve bandwidth reduction or additional bandwidth reduction for a given display system bit depth by encoding more grey levels for a given number of bit planes sent to the imager.

In conventional pulse-width modulator (PWM) methods, for any given pixel, the sequence of bit planes results in a sequence of bits of all 1's with a run length increasing with increasing grey level, followed by 0's for the remaining time window corresponding to the maximum level. Typically, in PWM a pixel will be turned on for a fixed amount of time (e.g., corresponding to a series of 1's in a frame) and turned off for a fixed amount of time (e.g., corresponding to a particular amount of 0's in a frame).

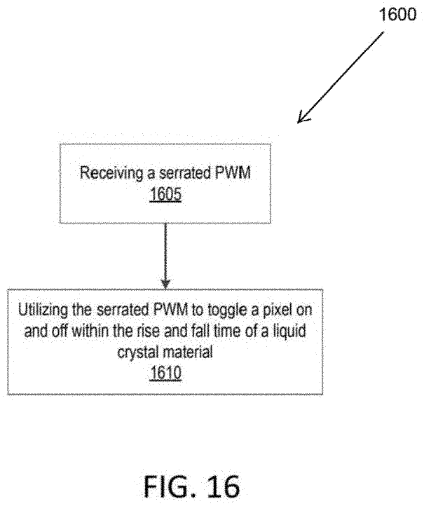

FIG. 16 illustrates a serration method in accordance with the present invention. In the serration method instead of, for example, turning a pixel on and leaving it on for a fixed amount or interval of time, the pixel is instead toggled (i.e., turned on and off or switched between an on and off state), wherein the off state is off for times shorter that the rise or fall time (which may or may not be equal) of the liquid crystal material. In a serration method in accordance with the present invention, instead of for example, turning a pixel off and leaving it off for a fixed amount or interval of time, the pixel is instead toggled (i.e., turned off and on or switched between an off and on state) during that same set or fixed period or interval of time, wherein the on state is on for times shorter that the rise or fall time (which may or may not be equal) of the liquid crystal material. A serration method in accordance with the present invention increases the number of gray scale levels (e.g., levels corresponding to the on and off states or resulting from the toggling of the state of a pixel) during a fixed interval of time. In an embodiment of the present invention, one or more serrated PWM and/or non-serrated PWM sequences (e.g., for each level that may be rendered by the spatial light modulator 156) may be stored in the Bit Plane LUT 135.

A serration method in accordance with the present invention includes turning off a pulse in the PWM for a short amount of time with respect to the rise time and fall time. For example, where a PWM has a rise time of approximately 400-500 milliseconds (ms), the serration may turn off the pulse of the PWM for approximately 30-120 ms.

FIG. 12 is a flow chart illustrating methods for performing a serration sequence 1200. The serration sequence 1200 involves optionally assigning one or more levels to a PWM drive method (step 1205). For example, a serration method in accordance with the present invention removes small portions of a given PWM pulse by inserting 0's within the run length of 1's, and thereby turning off the pulse for a given level in an intermediate bit plane. Removal of these portions (e.g., notches) from the PWM pulses serrates the pulses. In an embodiment of the present invention, a serration method in accordance with the present invention, additionally or alternatively, removes small portions of a given PWM pulse by inserting 1's within the run length of 0's, and thereby turning on the pulse for a given level in an intermediate bit plane.

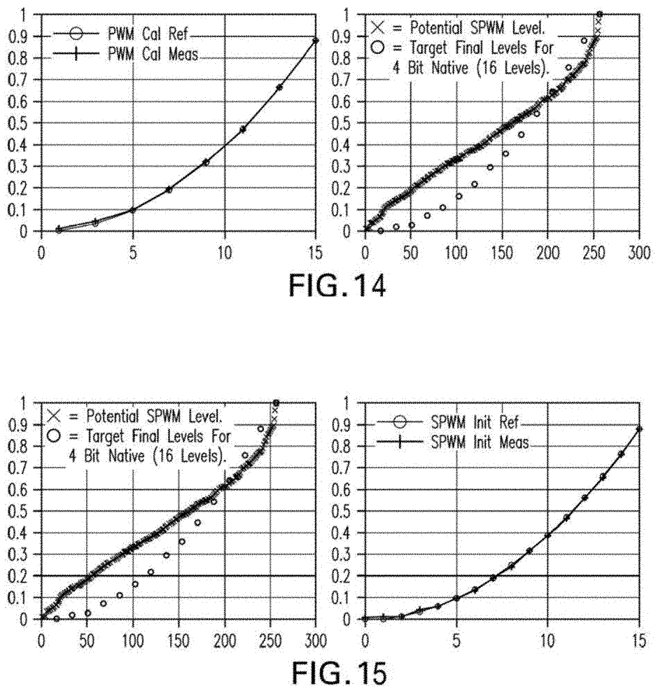

Once the PWM pulse is serrated, the serration sequence 500 calibrates output levels when using the serration method utilizing SPWM. Specifically, determining optimum bit sequences for SPWM levels given a set of PWM based levels and determine the drive sequence for each respective level with serrated PWM. Utilizing the serration method along with the checkerboarding method has an added benefit of reducing any artifacts caused by the SPWM. Calibrating output levels is described in greater detail below in association with FIGS. 14-15.

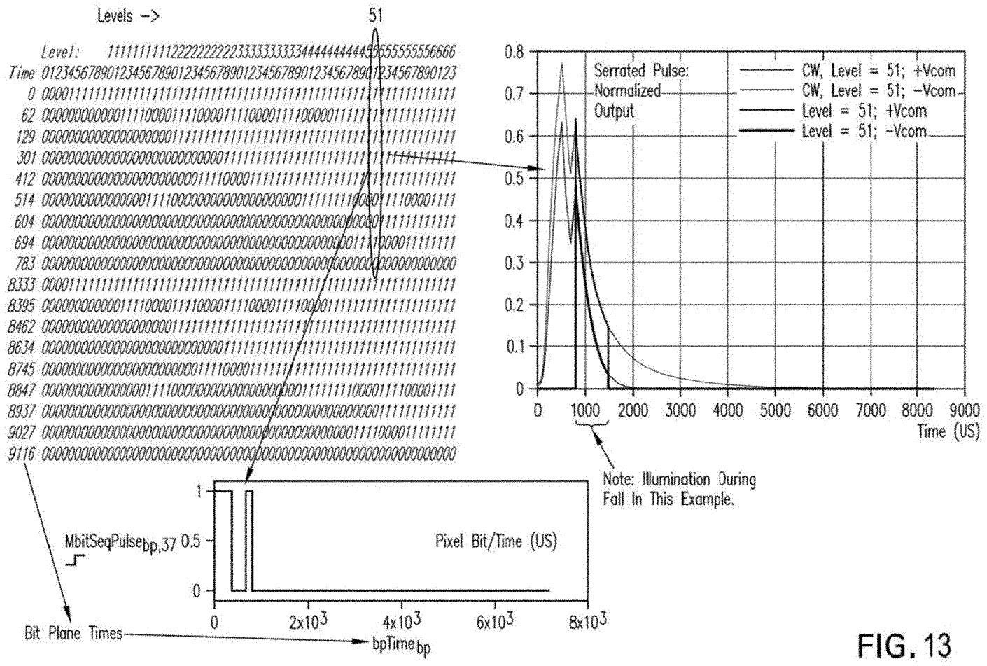

In some embodiments, these pulses and notches overlap creating a serrated pulse width modulation (SPWM). An example SPWM in accordance with the present invention is illustrated in FIG. 13.

FIG. 13 illustrates a bit sequence matrix for SPWM used in short persistence drive.

The matrix illustrated in the upper left of FIG. 13 is composed of one column of bit sequences per grey level. Note that this sequence has two repeated pulses per frame, the first for illumination and the second for DC balance to prevent liquid crystal ionic drift and plating. Bit planes are sent to the pixel electrodes of the imager at the designated time in the first column.

The digital waveform illustrated in the lower left of FIG. 13 corresponds to an example bit sequence circled within matrix for an example grey level (e.g., level 51 circled within the matrix).

The plot on the right of FIG. 13 illustrates overlaid plots of simulations of the resulting LCoS output serrated pulse in units of normalized reflectance. Blue and red traces show the first and second pulses of two pulses required to balance the DC voltage across the drive (via+and −Vcom), both for an example level of 51 out of 64 (0-63). The blue trace shows the entire LCoS pulse as if it were illuminated by continuous wave (CW) illumination for positive Vcom. Likewise for the red trace, but for negative Vcom to restore DC balance. It should be noted that the notch near the top of the pulse where it has been “serrated” corresponding to the two 0's in a row within the run length of 1's in the column for level 51 circled in the matrix. Superimposed on these serrated pulses are the illuminated portions of these pulses during a portion of the fall. The respective pulsed illumination is used normally to isolate the red, green and blue pulses for color independence (for reducing color bleed).

FIGS. 14-15 illustrate the two step process for calibrating output levels when using the serration method utilizing SPWM. Specifically, (1) determining optimum bit sequences for SPWM levels given a set of PWM based levels (FIG. 14, which implicitly requires selection of levels which will use PWM) and (2) determining the drive sequence for each respective level with serrated PWM (FIG. 15).

To determine the drive sequence in the serration method (FIG. 14), an algorithm selects a specific subset of PWM based levels corresponding to the number of bit planes (step 1210).

The chart on the left side of FIG. 14 illustrates that PWM levels determine bit plane times (step 1215). As illustrated over digital level (x-axis), the normalized light output level (y-axis) of a PWM calculated reference (depicted as a data line with “o” data points) and a PWM calculation measurement line (depicted as a line with “+” data points) track one other.

The chart on the right side of FIG. 14 illustrates potential SPWM output levels (vertical coordinate of each “x”) compared to reference, target output levels (“o”). Ideally, for each “o” there is a corresponding “+” at the same vertical coordinate. For example, 8 bit planes correspond to 256 levels (2 to the 8^{th} power). Each level in the subset is to be driven using conventional PWM, generate respective bit planes and calibrate bit plane timing for PWM drive. As illustrated, the target level (represented as “o” data points) and potential SPWM levels (represented as “x” data points).

To determine the drive sequence in the serration method (FIG. 15), the algorithm determines the drive sequence for serrated PWM output levels (step 1220). Specifically, the remaining grey levels, simulate (or otherwise determine) best bit patterns formed by replacing 1's with 0's in the bit sequences for the PWM. The left side of FIG. 15 illustrates corresponding bit plane potential levels and the right side of FIG. 15 illustrates level determined, where the SPWM initial reference is depicted as a data line with “o” data points and a SPWM initial measurement (or simulation) line is depicted as a line with “+” data points. The level is determined for each output level designated as SPWM, the “serrated” sequence of the respective closest matched output level evaluated from the ensemble of SPWM sequences is selected (step 1225).

Utilizing checkerboarding and/or the serration achieve both reduced persistence and reduced latency by significant factors sufficient to meet otherwise unreachable requirements for AR/VR/MR applications. For example, utilizing checkerboarding and/or serration will reduce latency by 15-50% when compared to conventional PWM techniques.

In some embodiments, the checkerboarding and/or the serration are utilized in imaging systems (e.g., in systems or devices including imagers and/or displays) that generate images (e.g., AR, VR, MR images). In an embodiment of the present invention, the checkerboarding system and/or method in accordance with the present invention and/or the serration system and/or method in accordance with the present invention enable low cost and improved quality display systems for AR, VR, and/or MR systems, devices, and/or methods. In an embodiment, the checkerboarding and/or the serration reduces bandwidth between video source and display.

As an illustrative example, the below table Relevant art is perhaps best represented by the pulse width modulation (PWM) drive method. The following table compares characteristics of a conventional PWM drive method and the current invention's SPWM, specifically an illuminated serrated pulse width modulation (ISPWM) impulse illuminated serrated PWM (ISPWM).

| | | ISPWM w/ | |
|---|---|---|---|
| Parameter | PWM | checker | ISPWM Direct |
| Persistence (ms) | ~8 | 2.1 | 2.1 |
| Latency | 1.0 | 0.15 | 0.3 |
| (normalized | | | |
| PWM) | | | |
| Frame Rate | >=90 w/GPU | >=90 w/GPU | >=90 w/GPU |
| (Hz, 3 | | | |
| color | | | |
| sub-frames) | | | |
| Relative Dark | 1 | ~1 (est. <=1 w/ | ~3 (est. <=1 w/ |
| Line Error | | GPU dither mod.) | GPU dither mod.) |
| Relative Color | 1 | ~0.25 (~2.1/8.3) | ~0.25 (~2.1/8.3) |
| Fringe | | | |
| Relative Color | 1 | ~1.3 (est. <=1 w/ | ~2 (est. <=1 w/ |
| Bleed | | GPU color LUT) | GPU color LUT) |
| Bit depth (3 | 12-15 native, | 12 native, | 12 native, |
| color bits) | 24 w/dithering | 12-18 w/GPU | 12-18 w/GPU |
| | | 24 w/dithering | 24 w/dithering |
| Approximate | 8 ms/(frame | ~.07-.22 (90 Hz- | ~.18-.66 (90 Hz- |
| Relative | period): | 333 Hz) | 333 Hz) |
| efficiency | (90-120 Hz): | Note that most of | Note that most of |
| (Brightness) | ~.72-1 | this reduction is | this reduction is |
| | | due to 2 ms/8 ms. | due to 2 ms/8 ms. |
| Contrast, | ~3000:1, no DA | ~1000:1, no DA | ~3000:1, no DA |
| sequential | >5000:1 est. w/ | >?5000:1 est. w/ | >5000:1 est. w/ |
| | DA | DA | DA |
| Relative | 1 | ~4 for 40-50 deg C. | ~4 for 40-50 deg C. |
| temperature | | ~10 for 32-40 deg | ~10 for 32-40 deg |
| sensitivity | | C. | C. |
| (% error/ | | | |
| degree C., | | | |
| MLC-2081) | | | |
| Required HMD | 1 | ~1/2³ | ~1/2² |
| LCoS BW/pixel | | | |

IV. Selected Features of the Technology

Some but not all of the benefits, advantages, motivations, and results of the present technology are described above, and some but not all of these are described in this section.

Checkerboarding and/or serration is used to improve and/or eliminate blurring artifacts in AR, VR, and MR applications. The achieved shorter rendering times enable an increased information rate required for such things as higher frame rates, direct view stereoscopic and omni-view (“holographic”) displays.

Improvement to blurring artifacts shorten pulses within the PWM and reduces latency/BW reduction latency, persistence, and/or bandwidth. Specifically, grey levels are utilized with less bit planes utilizing serrated PWM (SPWM).

Reduce the noticeability of fringe field effects, including dark line mitigation, from SPWM. Checkerboarding maximizes attenuation due to spatial gradient, but normal output level profile calibration directly mitigates this attenuation, so dark lines are less visible. Additionally, electronic pre-tilt via drive voltage selection (Vcom and Vpix) typically reduces WOB & dark line effects. Drive waveform correlation reduce differences in adjacent instantaneous low voltages, thereby also reducing these types of undesirable artifacts.

LCoS pulses and respective laser pulses are moved closer in time, without increasing color bleed. Checkerboarding mitigates color bleed because the first and third color spatiotemporally separated from the second color. Additionally, color correction LUTs are used to mitigate color bleed within the resulting color gamut.

Moving either the bit rotation or both bit rotation and bit plane LUTs upstream of drive devices and/or processes into graphic processing methods or processors or devices, such that frame buffers are not required in the drive processes associated with the drive device. Instead, only a subset of image data such as a smaller bit-plane FIFO or perhaps a color sub-frame memory reside in the LCoS processing chip. This reduces the required bandwidth between the upstream processor and the LCoS processing chip, reduces the required memory on the LCoS processing chip and results in a corresponding lower latency display system.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof. It will be apparent those skilled in the art that various modifications and variation can be made in the present invention without departing from the spirit or scope of the invention. Thus, it is intended that the present invention cover the modifications and variations of this invention provided they come within the scope of the appended claims and their equivalents.

Various embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

1-20. (canceled)

21. A method of displaying an image on a display device, comprising:
receiving a frame of image data comprising at least a first sub-frame of image data and a second sub-frame of image data;
deleting, based on whether the image data corresponds to an even sub-frame or an odd sub-frame, pixels from the image data:
wherein, for image data corresponding to an even sub-frame, even pixels are deleted from even lines of the image data and odd pixels are deleted from odd lines of the image data; and
wherein, for image data corresponding to an odd sub-frame, odd pixels are deleted from even lines of the image data and even pixels are deleted from odd lines of the image data;
driving, for each sub-frame of image data, each non-deleted pixel with a pulse at each non-deleted pixel, wherein sub-frames are driven in sequence with a first phase of a first pulse of a non-deleted pixel in a first sub-frame being offset from a second pulse of a non-deleted pixel in a second sub-frame, and wherein the first sub-frame and the second sub-frame are consecutive frames; and
illuminating each sub-frame of the image data with a light source for a color channel, wherein the color channel is selected from a plurality of color channels such that consecutive sub-frames are illuminated with different color channels.

22. The method of claim 21, wherein pixels corresponding to an even sub-frame have a first checkerboard pattern and pixels corresponding to an odd sub-frame have a second checkerboard pattern.

23. The method of claim 22, wherein the first checkerboard pattern and the second checkerboard pattern are complementary.

24. The method of claim 21, wherein the second pulse occurs in a time period between an end of the first pulse and a beginning of a third pulse.

25. The method of claim 24, wherein a time between when a beginning of the first pulse and an end of the third pulse is less than or equal to 2.1 milliseconds.

26. The method of claim 21, wherein the plurality of color channels include red, blue, and green color channels.

27. The method of claim 21, wherein even sub-frames are associated with a first color sequence and odd sub-frames are associated with a second color sequence.

28. The method of claim 21, wherein at least one of the first pulse and the second pulse is serrated.

29. The method of claim 28, wherein serrating the at least one of the first pulse and the second pulse includes serrating a bit plane sequence associated with the at least one of the first pulse and second pulse.

30. The method of claim 29, wherein serrating a bit plane sequence includes inserting off-times within the bit plane sequence.

31. The method of claim 29, wherein a serrated bit plane sequence includes a sequence of bits of ones interrupted by at least one sequence of zeros.

32. The method of claim 31, wherein the at least one sequence of zeros has an associated time frame that is less than a rise time and fall time of a liquid crystal material of the display device.

33. The method of claim 31, wherein the associated time frame of the sequence of zeros is 30 to 120 milliseconds.

34. The method of claim 31, wherein a grey level of the serrated bit plane sequence is calibrated to a grey level of an uninterrupted bit plane sequence.

35. The method of claim 34, wherein the device stores a plurality of serrated bit plane sequences end a plurality of non-serrated bitplane sequences each associated with a gray level.

36. The method of claim 21, wherein the light source is a laser or light emitting diode (LED).

37. A method of displaying an image on display device, comprising:
receiving image data;
for each frame of image data, driving each pixel according to a respective bit plane sequence resulting in a pulse at each pixel; and
wherein at least one of the bit plane sequences is a serrated bitplane sequence, wherein a serrated bitplane sequence includes a sequence of ones interrupted by at least one sequence of zeros; and
wherein a grey level of the serrated bitplane sequence is calibrated to a grey level of a non-serrated bitplane sequence.

38. The method of claim 37, wherein the at least one sequence of zeros has a time that is less than a rise time and fall time of a liquid crystal material of the display device.

39. The method of claim 37, wherein the associated time frame of the sequence of zeros is 30-120 milliseconds.

40. The method of claim 37, wherein the device stores a plurality of serrated bit plane sequences and a plurality of non-serrated bitplane sequences each associated with a gray level.
